(19) United States
(12) Patent Application Publication
(10) Pub. No.: US 2007/0296273 A1
(43) Pub. Date: Dec. 27, 2007

(54) Power supply network with integrated undervoltage protection in a passenger aircraft

(75) Inventors: Jorg Reitmann, Harsefeld (DE); Wolfgang Glahn, Hamburg (DE); Axel Konig, Hamburg (DE); Gerd Dueser, Jork (DE); Timo van der Plas, Buxtehude (DE); Stephan Tieck, Hamburg (DE)

Correspondence Address: PERMAN & GREEN, 425 POST ROAD, FAIRFIELD, CT, 06824, US

(73) Assignee: AIRBUS DEUTSCHLAND GMBH, Hamburg (DE)

(21) Appl. No.: 11/765,664

(22) Filed: Jun. 20, 2007

(30) Foreign Application Priority Data
Jun. 21, 2006 (DE) 10 2006 028 823.8

(51) Int. Cl. H02J 3/14

(52) U.S. Cl. 307/34

(57) ABSTRACT

The disclosed embodiments relate to a power supply network with integrated undervoltage protection for the energised consumers in a passenger aircraft having multiple consumers, with a power supply having multiple output connectors, wherein each consumer is connected to one of the multiple output connectors via a main supply wire, wherein each of the multiple consumers includes at least one individual load, each of which is designed for a predetermined supply voltage range. In order to ensure that the power consumption of individual consumers in a passenger aircraft power supply network is only limited relative to the overall power output to the extent that is absolutely necessary according to the requirements of overriding general conditions, and at the same time to minimise the corresponding weight of the cables in the aircraft, each of the multiple consumers according to the invention includes a voltage sensor for recording the supply voltage and a load controller, wherein the power draw of at least one individual load of the respective consumer is reduced when the supply voltage at the respective consumer falls below the preset minimum value.

The disclosed embodiments relate in general to a power supply network with integrated undervoltage protection for the energised consumers in a passenger aircraft and in particular to a controller for fail-safe supply in accordance with the preamble of claim 1.

Previously, the energy supply to consumers in a passenger aircraft has been designed for maximum loading, that is to say for values above the rated value. This ensures that the power supply to all consumers is assured and they can all be used at the same time. Specifically, this means for example that the design of the supply cables must be such that they only create a small voltage drop even at maximum current intensity. This is usually achieved by using suitable materials such as copper for the wiring and corresponding wire cross-sections.

The current generator must also be designed so that it is able to supply the necessary output even when all consumers are energised at the same time. However, since it almost never happens in practice that all consumers must be supplied at the same time, power supplies are dimensioned slightly smaller than necessary, in order to reduce the costs of components and their installation. In doing so, consideration is given to the fact that the power supply system may become overloaded if a larger number of consumers is energised than the number for which the system was designed. In order to prevent the entire system from failing in such an event, power supply systems have been suggested in the related art in which individual load components are shed.

For example, a controller for a power supply in which multiple outputs are connected to individual consumers is known from U.S. Pat. No. 6,046,513. As soon as the supply is to be drawn through additional outlets, the respective output power is measured. If the output power is below a maximum value, the supply through this outlet is enabled, if the output power is greater than the maximum value, it is disabled.

Moreover, U.S. Pat. No. 6,608,900 discloses a load controlling system for an electrical device in which a load is shed whenever the output voltage of the generator drops below a first threshold value, and the load is supplied again when the output voltage rises above a second threshold value again, the second threshold value being higher than the first threshold value.

In the related art cited, the load management system is integrated in the power supply. However, if the consumer consists of several individual elements, the load management system is not able to take this into account, it is only ever possible to disable the consumer as a whole, no provision is made for making a distinction between individual components of a consumer.

A power supply system for an aircraft is also described in French Patent No. FR 2 823 027, for example, in which a maximum electrical output is guaranteed for each consumer, the output actually consumed is monitored, and if necessary the operating conditions of the individual loads of the consumer are adapted accordingly so that the maximum guaranteed electrical output is not exceeded.

In this example of the related art, management is performed centrally, which means that additional cables must be provided, one for transmitting measurement signals and one for transmitting control signals. This increases the weight of the cabling in the aircraft, which has an unfavourable effect on the payload of the aircraft.

The object of the present disclosed embodiments is to minimise the quantity of cabling and the associated weight of cables in the aircraft. At the same time, it is intended to create a power supply network in an aircraft in which the power consumption of individual consumers relative to the overall power output is only limited to the extent that is absolutely necessary according to the requirements of overriding general conditions.

This object is resolved by the power supply network with integrated overload protection in a passenger aircraft as recited in claim 1. Dependent claims are directed to preferred embodiments of the disclosed embodiments.

The underlying idea of the disclosed embodiments is to provide each consumer consisting of a group of individual loads with its own, autarchic controller for shedding individual loads, the supply voltage in the group being collected at a central point. In the event that the supply voltage falls so severely that it drops below a predetermined threshold value, the power consumptions of certain individual loads of the consumer are reduced or removed from the network entirely (“shed”). This means that the consumer draws less power overall and the power supply is subjected to less load, so that the supply voltage is stabilised. In this way, a minimum supply voltage is always assured for all energised consumers and the voltage level never falls below this value. The cost of this is that some consumers are removed from the network, albeit very seldom and preferably only for very brief periods.

The power supply network according to the disclosed embodiments with integrated undervoltage protection for the energised consumers in a passenger aircraft having multiple consumers with a power supply having multiple output connectors, wherein each consumer is connected to one of the multiple output connectors via a main supply wire, wherein each of the multiple consumers includes at least one individual load, each of which is designed for a predetermined supply voltage range having a minimum value and a maximum value, is characterised in that each of the multiple consumers includes a voltage sensor for collecting the supply voltage and a load controller, wherein the power draw of at least one single load of the respective consumers is reduced if the supply voltage to the respective consumer falls below the predetermined minimum value.

The power supply network particularly includes a data bus, via which at least some of the consumers are connected to each other, and the load controllers of the consumers in question communicate with each other via this data bus. This provides the capability to establish a shedding strategy with regard to individual loads that extends over several consumers.

In addition, the power supply network preferably includes a central control unit, which is connected to the load controllers via the data bus. More complex shedding strategies may be implemented through the central control unit.

In particular, the individual loads in one consumer on the power supply network are shed according to a priority list.

In a preferred embodiment of the disclosed embodiments, the first single load that will be shed in a consumer on the power supply network is that is operationally least essential. This ensures that the devices that are indispensable for running the respective consumer remain on the network for as long as possible.

In another preferred embodiment of the disclosed embodiments, the first individual load to be shed in a consumer on the power supply network is the one with the greatest minimum value for supply voltage. In this way, particularly “sensitive” elements within the consumers are particularly protected.

In yet another preferred embodiment of the disclosed embodiments, the first individual component to be shed is the one whose current consumption is greatest. In this way, the cause of the dip in supply voltage is corrected immediately.

One advantage of the solution according to the disclosed embodiments consists in that the supply voltage is measured at or very close to the consumer, so that the voltage drop across the supply wire is insignificant and the “true” value of the supply voltage is obtained and does not have to be corrected downwards, as is the case if one attempts to deduce the voltage at the consumer from the voltage at the supply terminal, in which case the current across the supply wire must also be taken into account.

A further advantage consists in that not every load has to be connected directly to the central power supply, which would entail longer cables and the associated greater weight, but several individual loads are combined in a local consumer instead. Combining multiple individual loads enables savings to be made in terms of supply cables, and thus also materials and the weight thereof, and installing the supply network is relatively less labour-intensive.

Other features and advantages of the disclosed embodiments will be explained in the following description of embodiments, by way of example only, wherein reference is made to the accompanying drawing.

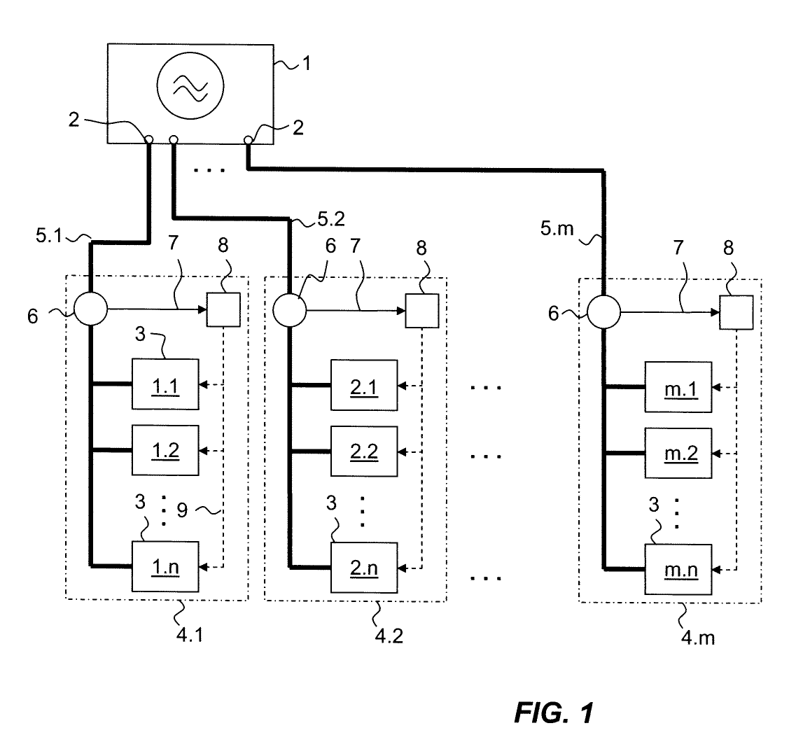

FIG. 1 is a schematic representation of a first embodiment of the power supply network.

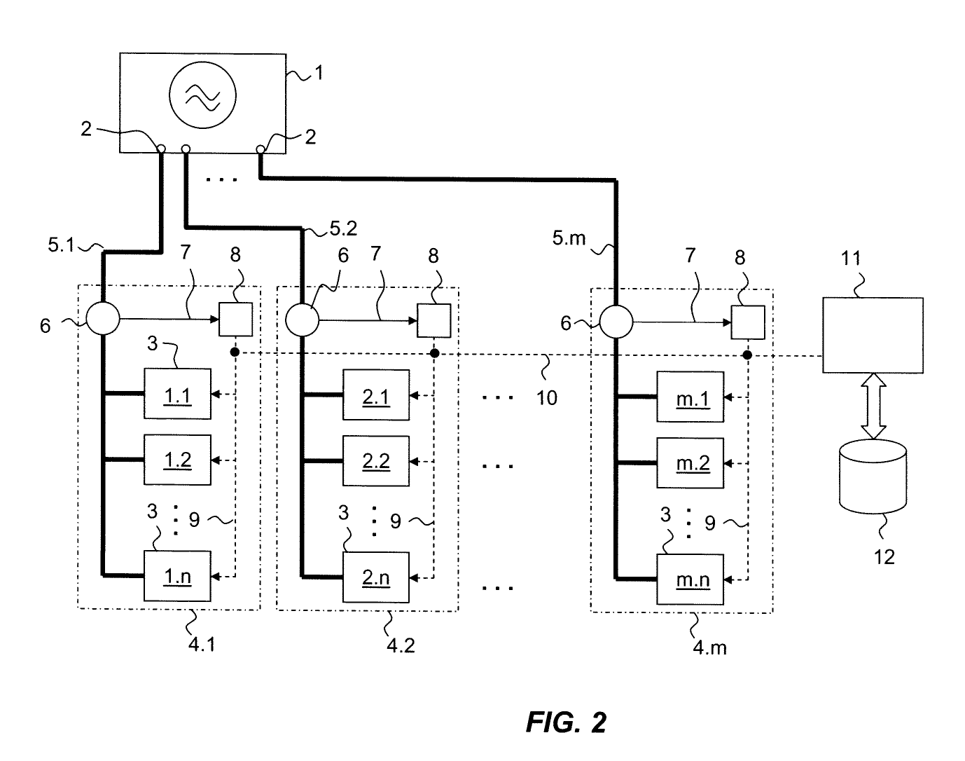

FIG. 2 is a schematic representation of another embodiment of the power supply network.

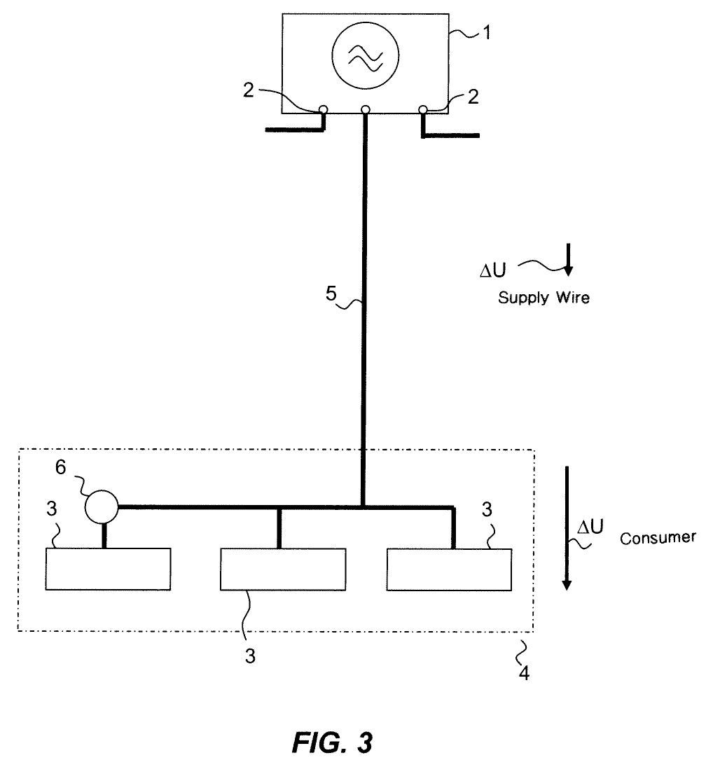

FIG. 3 shows an example of a consumer having multiple individual loads and the distribution of the voltage drop across the wire and the consumer.

Identical or equivalent elements in the figures are associated with the same reference numbers unless expressly indicated otherwise.

The power supply network for electrical consumers shown schematically in FIG. 1 includes a power source 1 with multiple connectors 2. Multiple individual loads 3 are supplied by power supply 1, and these are designated by “1.1” to “m.n”. They are combined in groups 4.1, 4.2 . . . 4.m. These groups 4.1, 4.2 . . . are referred to as consumers in the following text. Each of groups 4.1, 4.2 . . . 4.m is connected to a connector 2 of power supply 1 via a corresponding main supply wire 5.1, 5.2 . . . 5.m. Within the individual groups 4.1, 4.2 . . . 4.m., each individual load 3 is connected to the respective main supply wire 5.1, 5.2 . . . 5.m via its own wire. FIG. 1 shows an embodiment in which each individual load 3 is connected to main supply wire 5 in the manner of a “T branch”. But this is only an example, of course, and individual loads 3 may also loop through main supply wire 5.

An example of a consumer that is made up of a group 4 of individual loads 3 is the galley in an aircraft. The galley contains multiple devices 3, all of which are connected to power supply 1 via live main supply wire 5.1. Another example of a consumer that is made up of a group 4 of individual loads 3 is the group of devices that are integrated in a seat, for example for playback of entertainment programmes or for adjusting the seat.

According to the disclosed embodiments, if the onboard network, that is to say power supply 1, is overloaded or suffers a partial outage, a single device 3 or the entire group 4 is uncoupled from power supply 1 in order to ensure that the remaining devices are supplied properly. For this purpose, a control unit 8 is provided to monitor the operating parameters of a consumer group 4. The disclosed embodiments will now be explained with the supply voltage serving as an operating parameter.

The consumers are each designed for a specific nominal range of the supply voltage, and function faultlessly in this range according to the manufacturer. Outside of this range, undefined operating states may arise, which may cause generally unpredictable failures of consumers or individual device components, and ultimately lead to unpredictable breakdowns in the operating sequence of the consumers.

In order to avoid such a breakdown, the supply voltage is monitored at the consumer according to the disclosed embodiments. For example, as consumer 4.1 the galley and its various individual components is supplied via main supply wire 5.1 from power supply 1. The supply voltage that is incident at consumer 4.1 is measured constantly by a voltage sensor 6 at a measurement point which according to the disclosed embodiments is inside or immediately outside the consumer. Voltage sensor 6 is preferably integrated in consumer 4.1, but it may also be connected outside and upstream of the consumer. A significant advantage of this circuit arrangement of voltage sensor 6, that is to say its arrangement directly inside the consumer itself or immediately in front of it, is that a voltage drop across the feed wires may be disregarded, in particular a voltage drop across supply wire 5.1 for consumer 4.1 is irrelevant for the measured value acquisition by sensor 6.

The value measured by voltage sensor 6 is transmitted to a control unit 8 via a data circuit 7. Data circuit 7 as the input variable for control unit 8 is indicated with an arrow pointing to the right. Control unit 8 is preferably integrated in consumer 4.1, but it may also be arranged outside the consumer, like sensor 6. A significant advantage of integrating control unit 8 in consumer 4.1 itself consists in that control unit 8 may be replaced together with the actual consumer 4.1 if necessary. This is particularly advantageous if device-specific data that are used for shedding individual loads according to certain device specifications have been stored in control unit 8.

Control unit 8 is connected to individual loads 3 in the respective consumers 4.1, 4.2, . . . via a local bus 9. Control unit 8 passes a control signal via local bus 9, which signal may be addressed selectively to one of the individual loads 3 that are combined in the consumer. Bus 9 is indicated with an arrow pointing left, designating output variables from control unit 8. Besides the address of the device that is being addressed, the control signal also contains a command field containing information that is used to determine whether the device being addressed will remain energised or will disconnect itself from the network automatically. This feature will be described in greater detail later.

As was indicated previously, the supply voltage to a consumer must normally lie within a preset target range, and for example must not fall below a preset minimum value for the voltage. If this does occur, however, for example if a subgenerator of power supply 1 fails, individual loads in the main supply circuit must be shed in deliberate manner to avoid overloading the power supply. In the following, the galley supply will be considered for the purposes of the example. Here, the operating voltage is normally 115V, the supply voltage must not fall below 96V for the equipment. The generator supplies an output voltage of 115V at output 2 of the power supply.

For the purposes of dimensioning the feed lines in the aircraft, let it now be assumed that in normal operation the output voltage on the generator side fluctuates by as much as 7V. The result of this is that the effective voltage at the output of generator 2 may fall to 108V. If the voltage on the device side must not fall below 96V, this means that a voltage drop of no more than 12V across the supply line is permitted when the generator is delivering maximum current. The respective parameters for the supply wires may be deduced from the preceding.

If the voltage falls by more than 12V, for example because the cross-section of the wires is too small for the maximum current, individual loads must be removed (shed) from the network to prevent the occurrence of undefined operating states and therewith also unpredictable failures. Since load shedding does not take place according to a hard-wired sequence, but is effected by control unit 8 on the basis of the control parameters stored therein, the user may influence which of the devices remain active and which do not in the event of emergency shedding by entering the corresponding specified values for the control parameters. For example, the user may specify that the first individual loads 3 in a consumer 4.1, 4.2 . . . to be shed are those having the highest minimum supply voltage value. Thus this special individual load is protected separately in the event of a complete supply failure, and this individual load 3 is deliberately prevented from entering an undefined operating state.

In this context, the information regarding which of individual loads 3 in a consumer 4.1, 4.2 . . . are shed first, second, etc., may be stored in control unit 8 or in the individual loads themselves. For example, in a preferred embodiment of the disclosed embodiments, the current value of the supply voltage is transmitted via local bus 9 of the respective consumer 4.1, 4.2 . . . On the basis of this information, each individual load 3 decouples from the supply network independently of the other individual loads as soon as the supply voltage approaches a value that is critical for the respective individual load 3.

As an alternative to setting the shedding sequence in which the most sensitive device is removed from the network first, the user may specify that the first individual load 3 in a consumer 4.1, 4.2 . . . to be shed will be the one with the greatest power consumption. In this way, consumer 4.1, 4.2 . . . will be deliberately protected “against” this special individual load 3, because the individual load that is causing the failure of the supply voltage at the consumer will be decoupled.

In this shedding sequence strategy, shedding preferably takes place on the basis of the information in the command field of the control signal that is issued by control unit 8 via local bus 9 in the respective consumer 4.1, 4.2 . . .

Other alternatives regarding the shedding sequence strategy are conceivable. For example, the user may define a priority list indicating the order in which the devices are shed. In this way, it may be ensured that the devices which are essential for operation remain on the network for as long as possible, while “less essential” devices are shed in order to maintain uninterrupted operation. Under certain conditions, it is possible to remove an entire consumer constellation 4 from the network.

Local bus 9 of a consumer may particularly be a component of a data bus system that not only provides a connection with all the individual loads 3 within consumer 4.1, but also connects individual loads of different consumers 4.1, 4.2 . . . to each other. A power supply of this kind is shown in FIG. 2. The power supply network as shown in FIG. 2 essentially includes the same components as the power supply network of FIG. 1, but with the addition of a data bus 10, via which the individual components of different consumers communicate with each other. If such a bus 10 is already present in the aircraft's power supply and information system it is also used as in the embodiment of the disclosed embodiments shown in FIG. 2 to transmit data from individual control units 8, so that control units 8 are able to exchange information with each other, or the data from the individual control units 8 may be captured and monitored centrally. In other words, if a bus such as data bus 10 is already available, it is used for the purposes of the present disclosed embodiments as well as for its primary task. The advantage of this is that special fail-safe specifications do not need to be declared through the present disclosed embodiments, the bus is already approved for aeronautical because of its existing uses.

A central control unit 11 is provided as a higher level controller in the embodiment of FIG. 2 and is connected to a data storage device 12 as well as to data bus 10.

This provides the capability to shed loads and possibly switch loads 3 back in again later according to a predetermined strategy for multiple consumers, including a probability analysis of the subsequent trend in power consumption if a generator fails or a short circuit occurs in the device. Information about the minimum voltage for consumers, switching priorities, consumer grouping, a response catalogue and service support may be stored in memory 12.

However, the disclosed embodiments relates to more than shedding loads when the supply voltage falls below a specified minimum value. In addition, consumers that were shed during periods of undervoltage are preferably switched back in again automatically when the supply voltage has returned to a level above a switching value. However, in order to avoid oscillations between the switched on and switched off states, devices are switched on and off with a hysteresis. In this context, the consumers are switched off when the supply voltage falls below a lower threshold value, and they are not switched on again until the supply voltage has remained above an upper threshold value, which is greater than the lower threshold value, for a predetermined period of time.

FIG. 3 shows an example of the location of measurement point 6 of the disclosed embodiments. A main supply wire 5 leaves power supply 1 and is connected to one or more connectors of the power supply on one side and to consumer group 4 on the other side. Consumer group 4 combines three consumers 3. A voltage drop ΔU_{wire} takes place in main supply wire 5 due to the composition of main supply wire 5, that is to say its length and diameter. The supply voltage for consumer 4 dips by a value equivalent to this voltage drop. In order to enable individual loads 3 to be shed without reference to voltage drop ΔU_{wire}, the supply voltage is recorded at a location as close as possible to consumer 4, particularly inside consumer 4, for example at the input to consumer 4, as is shown in FIGS. 1 and 2. Inside consumer 4, however, individual loads 3 are also connected to the supply input of consumer 4 by feed wires. In order for it to remain independent of their finite output resistances as well, the supply voltage as an indicator for shedding individual loads 3 is preferably measured at the last element 3 in consumer 4. In this way, the internal voltage drop across the feed wires to individual load elements 3 has also been eliminated. At the same time, of course voltage drop ΔU_{consumer} across consumers 3 is considerably larger than voltage drop ΔU_{wire} across the supply wire, which is also indicated with an arrow in FIG. 3, and the voltage drop across the internal feed wires (not shown) of individual loads 3.

It will be clear to one skilled in the art that the preceding explanations are not limited to the supply of power to galleys, but are equally applicable, for example, to the single seat supply of passenger seats or groups of passenger seats.

1. A power supply network with integrated undervoltage protection for the energised consumers in a passenger aircraft having multiple consumers, with a power supply having multiple output connectors, wherein each consumer is connected to one of the multiple output connectors via a main supply wire, wherein each of the multiple consumers includes at least one individual load, each of which is designed for a predetermined supply voltage range having a minimum value and a maximum value,
characterized in that
at least some of the multiple consumers include a voltage sensor for recording the supply voltage and a load controller,
wherein the power draw of at least one individual load of the respective consumer is reduced if the supply voltage at the respective consumer falls below the predetermined minimum value.

2. The device as recited in claim 1, including a data bus via which at least some of the consumers are connected to each other, wherein the load controllers of the corresponding consumers communicate with each other via this data bus.

3. The device as recited in claim 2, including central controller that is connected to the load controllers via the data bus.

4. The device as recited in any of the previous claims, in which the individual loads in a consumer are shed according to a priority list.

5. The device as recited in claim 4, in which the first individual load in a consumer that will be shed is the one that is operationally least essential.

6. The device as recited in claim 4, in which the first individual load in a consumer that will be shed is the one with the greatest minimum value for the supply voltage.

7. The device as recited in claim 4, in which the first individual load in a consumer that will be shed is the one with the greatest power consumption.
